(19) United States
(12) Patent Application Publication
(10) Pub. No.: US 2026/0244610 A1
(43) Pub. Date: Aug. 20, 2026

(54) LARGE LANGUAGE MODEL-BASED PROCESSES FOR AUGMENTING AND CREATING MACRO-ONTOLOGIES

(71) Applicant: Dell Products L.P., Round Rock, TX (US)

(72) Inventors: Ibrahim Abu Alhaol, Nepean (CA); Mustafa Al-Bado, Cork (IE); Said Tabet, Austin, TX (US); Gwenael Poitau, Montreal (CA)

(21) Appl. No.: 19/056,028

(22) Filed: Feb. 18, 2025

(51) Int. Cl. G06F 16/23; G06F 40/40

(52) U.S. Cl. CPC G06F 16/2365; G06F 40/40

(57) ABSTRACT

Creating and/or augmenting macro-ontologies is disclosed. A macro-ontology management system receives an update and, in response, retrieves an update and a macro-ontology. The macro-ontology management system determines whether the update relates to an inter or intra-ontology update. If an intra-ontology update, a micro-ontology is updated. If an inter-ontology update, the update is validated objectively and contextually and, if validated, the macro-ontology is updated accordingly, optimized and stored.

### TECHNOLOGICAL FIELD OF THE DISCLOSURE

Embodiments disclosed herein generally relate to structures that store data or information and to managing the structures. More particularly, at least some embodiments relate to systems, hardware, software, computer-readable media, and methods for managing an ontology and more particularly for managing macro-ontologies, which includes creating and/or augmenting macro-ontologies.

### BACKGROUND

A variety of tools exist for using and managing data. Large language models (LLMs) are examples of artificial intelligence systems that are capable of interpreting and producing text that closely resembles natural human language. LLMs have broad applicability in various fields and are particularly useful in applications that depend on language analysis and language generation.

LLMs may use various data sources in addition to their training for generating responses to a query. Examples of the sources may include graphs of various types including knowledge graphs and ontologies. A knowledge graph, for example, is a graphical representation of knowledge and may illustrate how different concepts, entities, and events interconnect. Knowledge graphs allow large amount of data to be navigated and provide insights into how various pieces of data are interrelated. Knowledge graphs are often used in applications such as semantic web services, data integration, and artificial intelligence.

Another example of a data source is an ontology. While an ontology has various similarities to a knowledge graph, an ontology is a formal representation of knowledge as a set of concepts withing a domain and the relationships between those concepts.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1A discloses aspects of extracting text, including ontology triples, from an input source;

FIG. 1B discloses aspects of extracting text from an input source;

FIG. 1C discloses aspects of an ontology, which includes a micro-ontology;

FIG. 2A discloses aspects of a system for creating and/or augmenting a node database;

FIG. 2B-2C discloses aspects of examples for creating and/or augmenting a node database or an ontology;

FIG. 3A-3C discloses aspects of creating and/or augmenting relationships in a micro-ontology;

FIG. 4 discloses aspects of a method for creating and/or augmenting a micro-ontology;

FIG. 5A-5B disclose aspects of creating and/or augmenting a macro-ontology;

FIG. 6 discloses aspects of a method for creating and/or updating a macro-ontology; and

FIG. 7 discloses aspects of a computing device, a computing system, or computing entity.

### DETAILED DESCRIPTION OF SOME EXAMPLE EMBODIMENTS

Embodiments disclosed herein generally relate to ontology management. More particularly, at least some embodiments relate to systems, hardware, software, computer-readable media, and methods for managing ontologies, which may include creating and/or augmenting macro-ontologies. Managing ontologies may further relate to managing relationships among ontologies and/or micro-ontologies in a macro-ontology.

Embodiments of the invention relate to ontologies and are discussed in the context of web ontology language (OWL) and resource description framework (RDF). Embodiments of the invention are further discussed in the context of ontologies that are constructed using triples. Embodiments of the invention, however, are not limited to these languages, frameworks, and methods of ontology construction. Other frameworks may include relational models, taxonomic hierarchies, or the like. The type of ontology selected for a given purpose may depend on the domain of the ontology. In addition, embodiments of the invention may be adapted to managing other structures such as linked structures, knowledge graphs, network graphs, and the like.

Generally, an ontology may be represented as a graph using nodes and edges. The nodes of an ontology may represent, by way of example only and not limitation, classes and instances. Classes may represent the categories of a domain while instances may be specific examples of a class. Relationships (e.g., edges) may define how classes are related to each other. Classes and instances may be associated with attributes, which may relate to properties or characteristics of a class or instance. An ontology may also be associated with rules that may determine or define how classes, instances, and relationships interact.

An ontology is often constructed using building blocks such as triples. OWL and RDF are examples of web technologies that employ triples. A triple (e.g., subject, predicate, and object) is used to define or describe knowledge in an ontology. By way of example, the subject may be the class being described, the object may be the value or instance associated with the subject via the predicate, which describes the relationship of the subject to the object. Some objects are, more specifically, literals.

RDF is an example of a formal structure that may be used within a domain of knowledge. RDF is often used as a framework to represent data on the web.

For example, a triple may be expressed in natural language as follows:
Arizona (subject) includes a city (predicate) Phoenix (object).

In RDF, this triple may be expressed as follows:
http://example.org/Arizona,
http://example.org/includescity
http://example.org/Phoenix.

In this example, each part of the triple is identified by a URL (Uniform Resource Locator). Triples may be used, by way of example only, to describe class hierarchies (e.g., city is a subclass of State), attributes (e.g., city has a population of number), and relationships between entities (e.g., cities require water). A web ontology language (OWL) ontology is another example that may be used to represent, define, and/or store knowledge within a specific domain.

An ontology, as previously stated, is often represented by nodes and connections or relationships. However, creating nodes or entries in an ontology is a challenging task. Ontologies often represent extensive volumes of data with intricate relational structures. The complexity of ontology management is evident in the task of ensuring uniformity while minimizing human errors and biases and in the task of integrating new information to adapt to the ever-shifting landscape of the ontology's domain. These tasks are further complicated by the need for accuracy, rigorous validation and the need to interact with a variety of data sources.

As previously stated, an ontology is a formal representation of knowledge as a set of concepts within a domain and the relationships between those concepts. A macro ontology may be a general overarching ontology that encompasses a wide range of domains and that provides a broad view of knowledge and its interconnections. A micro-ontology may be a specific and fine-grained ontology focused on a narrow domain or subject area.

In the knowledge management landscape, macro-ontologies may be configured to store or represent large sets of data. Conventionally, macro-ontologies are managed manual and in an ad hoc manner, which is challenging and time consuming, considering the large amount of data. Embodiments of the invention relate to merging smaller pieces of data into large well organized data sets (e.g., macro-ontologies) with reduced or minimal human interventions. Embodiments of the invention advantageously allow large data sets or macro-ontologies to be managed more effectively and ensure that these extensive data or information sets remain accurate and useful.

Manually creating and managing macro-ontologies faces challenges that include scalability, inconsistencies, and an extensive demand on time and resources. As data volumes expand and the complexity of knowledge systems increases, manually curating and updating macro-ontologies to reflect high-level knowledge domains accurately becomes increasingly difficult. Bottlenecks arise within information systems that obstruct the efficient exploitation of the vast quantities of data produced daily. Embodiments of the invention relate to an automated system that can dynamically assemble and refine macro-ontologies and absorb micro-ontologies into a unified structure that mirrors specific contexts and objectives. Embodiments of the invention further incorporate a validation mechanism to ensure integrity and relevance of the macro-ontology. Embodiments of the invention relate to automated operations configured to synthesize extensive information into well-defined, high-level ontologies with reduced human oversight, thereby enhancing the precision and functionality of knowledge representations.

Ontologies, including macro-ontologies are often created from various sources. Macro-ontologies may include or relate multiple ontologies, which may further include micro-ontologies. To create a macro-ontology, it may be necessary to extract information from those sources. As information is extracted, entries (e.g., subject nodes, object nodes, and/or relationships) may be created and added to a node database. In one example, a node database may store nodes and/or relationships (e.g., subject nodes, relationships (predicates), object nodes). In one example, a node database may store entries that may be the building blocks of ontologies. In other words, entries in the node database may be retrieved and incorporated into an ontology such as a macro-ontology.

When building an ontology, triples (e.g., subject, object, predicate) may be retrieved from a set of extracted text and management operations including node creation operations, node augmentation operations, or the like may be performed based on the triples included in the extracted text. More specifically, entries in the node database may be constructed or generated from extracted text, which is generated from various sources.

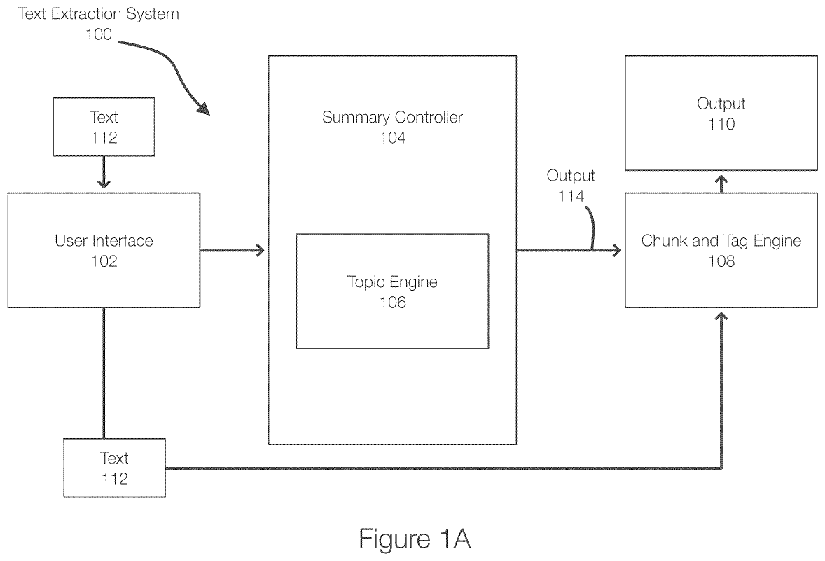

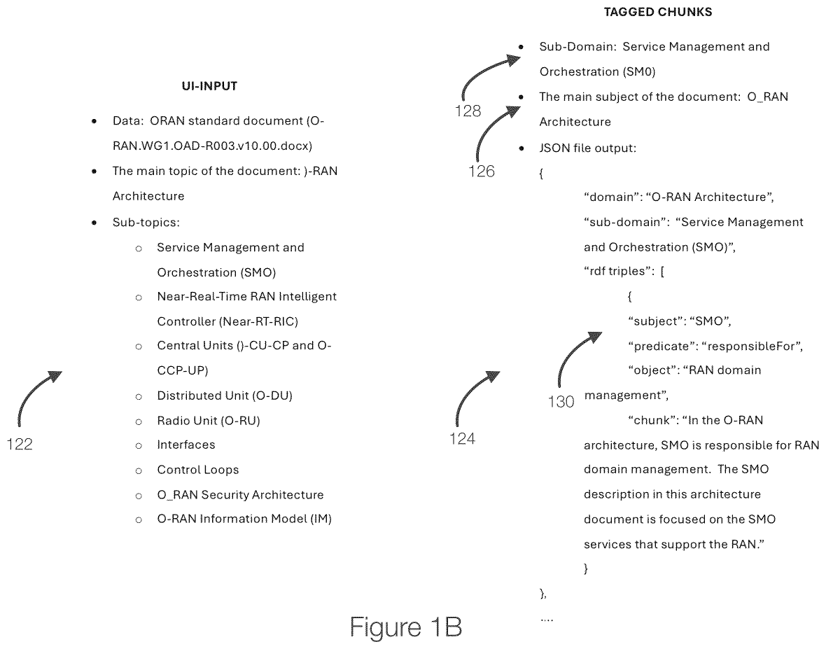

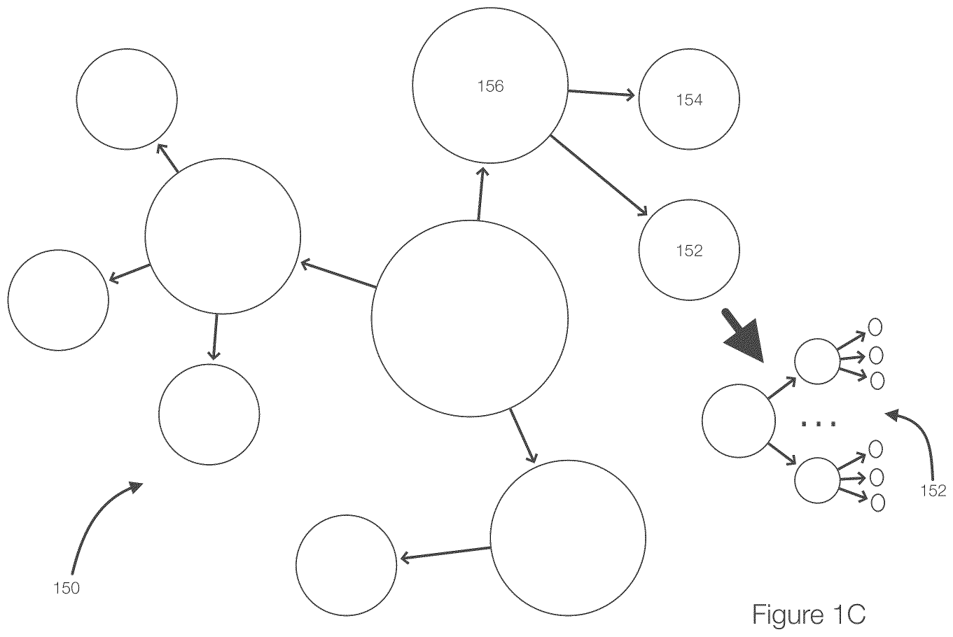

FIG. 1A discloses aspects of generating extracted text from a source. FIG. 1A illustrates an example of text extraction system 100 (system 100). In one example, text 112 (e.g., a document or other source or portion thereof) is input to the system 100 via a user interface 102. The text 112 is provided to a summary controller 104 that includes a topic engine 106. The topic engine 106 may include a large language model (LLM) configured to identify and summarize main topics and sub-topics included in the text 112. Thus, the response or output 114 of the topic engine 106 (or summary controller 104) may include main topics (domains) and sub-topics (sub-domains) of the text 112.

The text 112 and the output 114 of the topic engine 106 are provided to the chunk and tag engine 108 (engine 108). The engine 108 may include an LLM configured to craft triples (subject, predicate, object) from the text 112 based on context. The context may include the main topics and sub-topics of a domain identified by the topic engine 106 and included in the output 114. The context may also include chunks included in the output 114 and/or the text 112 itself. In one example, the output 110 of the engine 108 may include tagged chunks or tagged text. The output 110 may be a source of triples (a set of triples) that may be evaluated for inclusion in an ontology.

FIG. 1B discloses aspects of generating tagged chunks from user input. FIG. 1B illustrates text 122, which is an example of the text 112, that may be input to the system 100 via the user interface 102 to the summary controller 104. The topic engine 106 may receive the text 122. The text 122 may be used to prompt an LLM and the response of the LLM may include a main topic or domain (e.g., main domain 126) and/or sub-topics or sub-domains (e.g., sub-domain 128).

The engine 108 is configured to generate a triple 130 (or multiple triples) from the text 122 and the context. The context may include the domain 126 and/or sub-domain 128 generated by the summary controller 104 and/or the text 122 or chunks therein. In this example, the extracted text 124 is an example of the output 110 of the system 100. The extracted text 124 or portions thereof may be stored in a node database.

FIG. 1C discloses aspects of ontologies, including macro-ontologies and micro-ontologies. FIG. 1C generally illustrates a macro-ontology 150. The macro-ontology 150 may include or represent a wide range of domains and may include ontologies and micro-ontologies. For example, the ontology 156 may represent a particular domain of the macro-ontology 150. In this example, the micro-ontologies 152 and 154 may each represent a specific domain (e.g., a sub-domain) or narrow subject matter of the domain represented by the ontology 156. For example, if the domain of the ontology 156 relates to O-RAN (Open Radio Access Network), the domain of the micro-ontology 152 may focus on or be RIC (RAN intelligent controller). The focus or subject matter of the micro-ontology 152 may be narrower than the domain or subject matter of the ontology 156 and may focus, for example, on Near-RT RIC (Near-Real-Time RIC). The micro-ontology 152 may capture and articulate fine-grained and specialized knowledge within a specific domain.

Embodiments of the invention are configured to create and/or augment a macro-ontology in part by ensuring that only entries are added in appropriate and relevant portions of the macro-ontology. For example, an entry that is not germane to a particular micro-ontology may be germane to a different micro-ontology. Thus, entries considered for inclusion in a target micro-ontology may be included or rejected. Creating and/or augmenting macro-ontologies may include establishing intra-ontology relationships and/or inter-ontology relationships.

In embodiments of the invention, large language models (LLMs) may be configured for various purposes including semantic understanding, which facilitates ontology creation/construction. LLMs may be configured to validate ontology entries, which may include ensuring that relationships and nodes withing an ontology are consistent and logically coherent. Validating an ontology (e.g., macro, micro) may also include determining whether the defined relationships in the ontology accurately reflect their real-world usage and associations. LLMs may be further configured to perform ontology documentation, which may include generating descriptive documentation for ontologies. The documentation may explain relationships between entities and provide examples of usage. Ontology documentation may also include translating the documentation into other languages, making the ontology accessible to a broader audience.

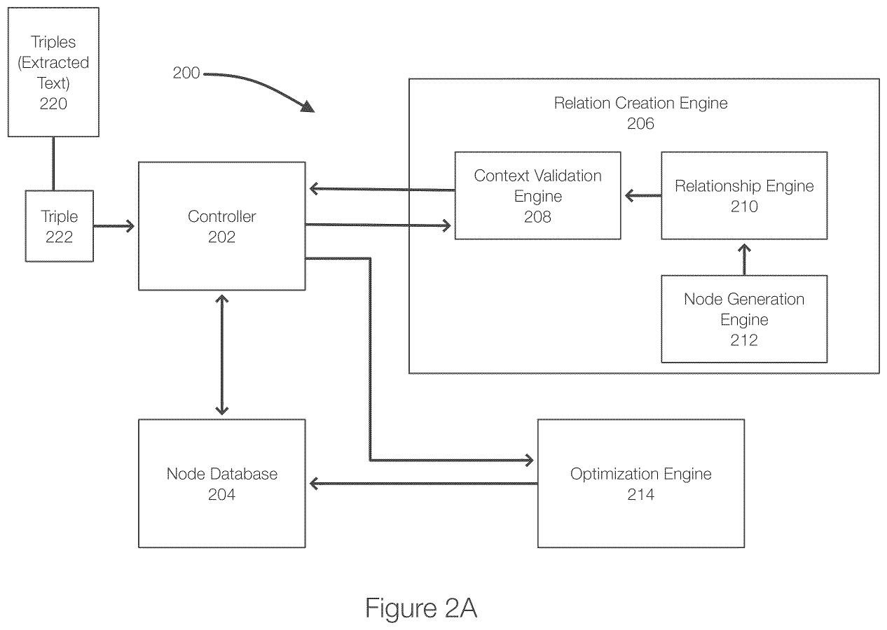

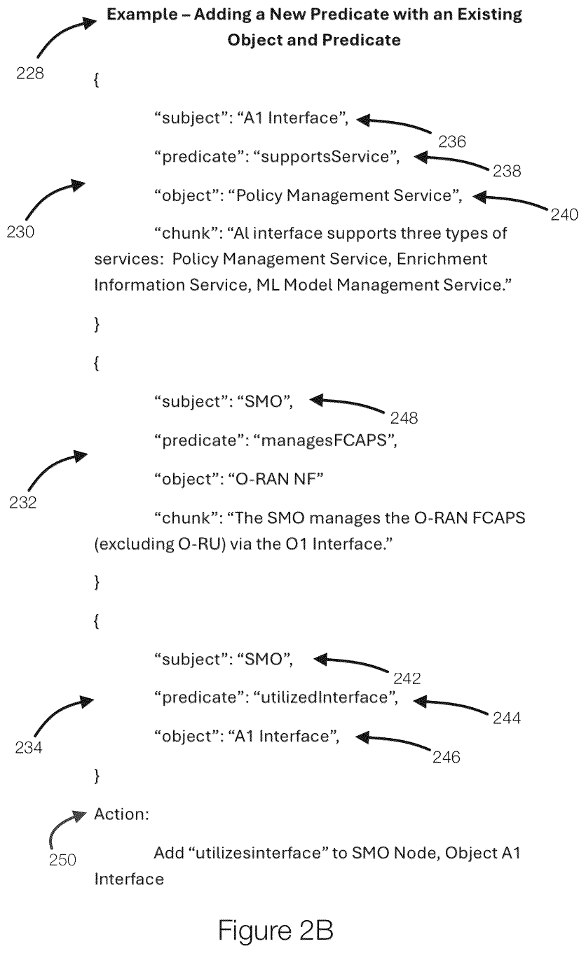

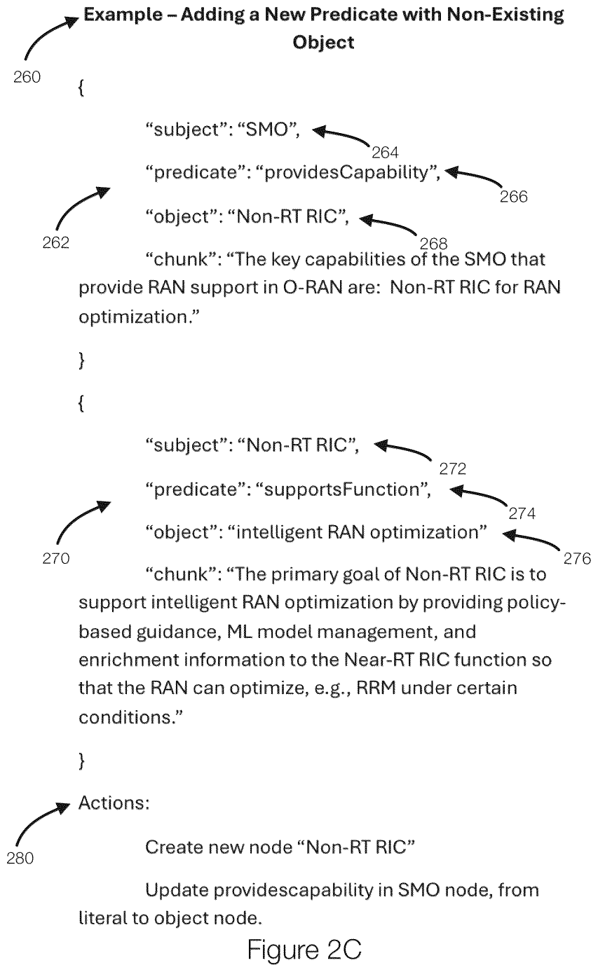

FIGS. 2A-2C discloses aspects of creating entries (e.g., subject nodes, object nodes, relationships (or predicates)) based on triples included in extracted text. FIG. 2A discloses aspects of augmenting and/or creating ontology nodes. FIG. 2A illustrates a relation creation system 200 (system 200) configured to augment and/or create ontology nodes. Creating ontology nodes may include one or more of creating subject nodes, object nodes, and/or relationships between nodes. In this example, a node database 204 included in or accessible by the system 200 may store entries (e.g., subject node, relationship, object node) of an ontology or the ontology itself. However, the entries in the node database 204 may not be associated with any particular ontology.

A controller 202 of the system 200 may have access to triples 220, or the extracted text generated by the system 100. The system 200 may be configured to evaluate the triples 220 and generate additional nodes and/or augment existing nodes in the node database 204. In one example, a controller 202 may check for the availability of a triple in the triples 220. In one example, the triples 220 are processed to generate new nodes for the node database 204 or to augment existing nodes in the node database 204.

In this example, a triple 222 is available (e.g., retrieved from the node database 204) for processing by the system 200. The triple 222 may include each of a subject, a predicate, and an object. The triple 222, which may also include chunks or extracted text and the controller 202 may also receive the chunks and other data in the extracted text associated with the triple 222.

The triple 222 is evaluated to determine whether nodes in the ontology or in the node database 204 need to be created or updated. More specifically in one example, the subject(S) of the triple 222 may be used to determine whether a subject node exists in the node database 204. If the subject node for the triple 222 is not present in the node database 204, the subject node for the subject of the triple 222 is created.

In one example, determining whether a subject node exists for the subject of the triple 222 is performed semantically. This may be achieved, in one example, using embeddings to determine whether a subject node for the subject of the triple 222 is present in the node database 204. The object (O) of the triple 222 may be similarly evaluated to determine whether an object node for the object of the triple 222 exists in the node database 204.

Next, a predicate relationship (P), based on the predicate in the triple 222, is established between the subject node and the object node if the object node exists as a node in the node database 204. If the predicate included in the triple 222 serves as a predicate for a literal, the object node is a literal (e.g., a specific value such as a date, a number, or other data type). As previously stated, a literal node may be created in the node database 204. If an object node does not exist, the object node may be created prior to creating or establishing the relationship.

In some examples, even if the subject node and the object node exist in the node database 204, the predicate included in the triple 222 may not be present in the node database 204. In one example, the relation creation engine 206 is used to create an entry that may include nodes and/or a relationship (predicate) based on the triple 222 and/or the associated chunks. In one example, the relation creation engine 206 may include various engines that are each configured for a different purpose.

For example, the relationship engine 210 is configured to generate a relationship. More specifically, the relationship engine 210 may include an LLM configured or fine-tuned to determine whether the predicate in the triple 222 should be a relationship between nodes or between a node and a literal. This may be based on the extracted text associated with the triple 222. The relationship engine 210, for example, can evaluate the object in the triple 222 and determine whether the object is more likely to be a literal (e.g., a value, or data) or a sub-class or sub-category.

In one example, the LLM of the relationship engine 210 may analyze the extracted text (e.g., domain, sub-domain, chunks) associated with the triple 222 to determine a nature of the predicate. The relationship engine 210 determines whether the predicate should represent a relationship between two nodes (entities) or between a node and a literal (attribute or value). The relationship engine 210 uses its understanding of the context to make this determination. The relationship engine 210 considers the semantics of the text and the roles of the entities involved. Based on the analysis, the relationship engine 210 generates an appropriate predicate that accurately reflects the relationship or attribute described in the text. The LLM of the relationship engine 210 may be fine-tuned on a specific dataset related to the domain of interest. This dataset may include examples of triples with predicates that represent relationships between nodes and between nodes and literals.

The node generation engine 212 is configured to generate a node when necessary (e.g., a subject node, an object node). More specifically in one example, the relationship engine 210 is configured to determine whether a predicate should be a relationship between nodes (e.g., a subject node and an object node) or between a subject node and a literal object. If necessary, the node generation engine 212 is configured to generate a suitable object node for the predicate.

The node generation engine 212 may include an LLM that is configured or fine-tuned to generate object nodes or literals, if necessary, based on the extracted text of the triple 222. In one example, the node generation engine 212 generates a node and the relationship engine 210 may determine whether the node is an object node or a literal.

The combination of pre-training and fine-tuning allows the LLM of the node generation engine 212 to effectively generate nodes that are contextually relevant and semantically accurate. For example, a triple may include the following:
Subject: “Albert Einstein”
Predicate: “discovered”
Object: “Theory of Relativity”

Assuming that that nodes for the subject and/or the object are not present in the node database 204, inputting the triple into the node generation engines as a prompt may result in the creation of nodes. For example, the node generation engine may generate nodes for “Albert Einstein” (subject node) and “Theory of Relativity” (object node). In addition, the node generation engine 212 (or the relationship engine 210) is configured or trained to understand that “discovered” is a relationship between the subject node “Albert Einstein” and the object node “Theory of Relativity”.

The context validation engine 208 is configured to validate the nodes, and/or the relationship generated in the relation creation engine 206. In one example, the context validation engine 208 is configured to validate the new relationship (subject node, relationship, object node). More specifically in one example, the context validation engine 208 interprets the triple (subject node, relationship, object node) to understand the context and the specific relationship being validated. Next, the context validation engine 208 analyzes the context to ensure that the relationship makes sense within the given domain.

In one example, this may include or involve:
Consistency Check: Verifying that the relationship is consistent with known facts and data; and
Relevance Check: Ensuring that the relationship is relevant and appropriate for the subject and object nodes.

If the validation performed by the context validation engine 208 fails, adjustments or corrections may be performed to the triple 222 and the relation creation operation may be repeated. Adjustments, by way of example only, may include correcting factual errors (e.g., correcting any inaccuracies in the information included in the extracted text), providing more specificity (e.g., making the relationship more specific or precise to better reflect the intended meaning), providing clarity (e.g., rephrasing the relationship to ensure that the is clear and unambiguous), and/or rejecting the new or proposed entry.

For example, the context validation engine 208 may be trained with or have access to source material of the relevant domain. For example, validating the relation (or node) may include receiving the relationship and submitting the relationship to an LLM to determine whether the relationship is valid and acceptable for inclusion in the ontology. In one example, the LLM may be able to determine whether the new relation is valid, true, or the like in the context of the domain, for example by comparing the entry to source documents of the domain, based on training, or the like.

For example, an entity that sells computing hardware, software, cloud-services, or the like may build or construct an ontology whose domain is computing systems and services. The LLM of the context validation engine 208 may include or have access to a knowledge base (and/or other sources) that stores computing standards, product documentation, white papers, or the like. This information allows the LLM of the context validation engine 208 to validate the relationship and/or node(s) being created/augmented.

Once the relationship is validated by the context validation engine 208, the result (e.g., subject node, relationship, and/or object node) is provided to the controller 202. The controller 202 may coordinate with an optimization engine 214 configured to enhance the relationship created/augmented by the relation creation engine 206. In one example, the optimization engine 214 may perform optimizations such as consistency optimizations, which may include aligning the relationship with existing data and standards to maintain consistency across the ontology, and clarity optimizations, which may include making the relationship more clear or more unambiguous to avoid or reduce misinterpretations. When completed, the node database 204 is updated with the new information (e.g., a new/augmented subject node, object node, and/or relationship).

FIG. 2B discloses aspects of examples for creating and/or augmenting nodes in a node database or in an ontology. In particular, FIG. 2B illustrates an example 228 of adding a new predicate to a node database (e.g., the node database 204). FIG. 2B also illustrates examples 230 and 232, which exist in the node database 204. Thus, the example 230 is associated with a subject node 236, a predicate 238, and an object node 240. The examples 230 and 232 represents, in one example, relationships or entries, such as the entries or relationships being created by embodiments of the invention.

FIG. 2B also illustrates an example of a triple 234 that is being processed by the system 200. The triple 234 is associated with a subject(S) 242, a predicate (P) 244, and an object (O) 246. In this example, the node database may be searched semantically for the subject node 242. The search determines that that subject 242 is already present in the node database as the subject node 248 in the example 232. As a result, the subject node for the subject 242 of the triplet 234 does not need to be created.

Next, it is determined that the object 246 of the triplet 234 also exists as the subject node 236 in the example 230. Thus, in this example, the subject node 236 may augmented to be an object node (not a literal in this example).

The predicate 244 of the triplet 234, in this example, is not present in the node database 204. As a result, the relation creation engine 206 is used to determine whether the predicate 244 should be a relationship between the node 248 and the node 236 in the node database 204. The relationship engine 210 includes an LLM that is configured to determine whether the predicate 244 should be a relationship. If necessary (e.g., assuming that the object 246 is not present in the node database 204), the node generation engine 212 may create or generate a suitable object node for the relationship being created or augmented.

After the relationship engine 210 determines that the predicate 244 should be a relationship between the nodes 248 and 236, the context validation engine 208 may validate the relationship. If the context validation engine 208 fails the validation, adjustments may be made (e.g., to the subject, predicate, and/or object of the triple) and the relation operation may be repeated. Once the relationship is validated by the context validation engine 208, the new entry is submitted to the optimization engine 214 by the controller 202. Once optimized, the new relationship is added to the node database 204. More specifically, the predicate 244 is added to a relationship, which relates the node 248 to the node 236 via a predicate. The node database thus includes a relationship between the subject node 248 and the object node 236. The node 236 is augmented and is both a subject node and an object node.

FIG. 2C discloses aspects of creating and/or augmenting nodes in an ontology. In this instance, FIG. 2C illustrates an example 260 of adding a new predicate to an object node that does not exist in the node database 204. FIG. 2C illustrates an example 262 and a triple 270 being considered by the system 200. The example 262 includes a subject node 264, a predicate 266, and an object node 268. The triple 270 includes a subject 272, a predicate 274, and an object 276.

In this example, the subject 272 does not exist in the node database 204 (e.g., not in the example 262 as a subject node). However, the subject 272 exists as an object node 268 (currently a literal). Thus, a subject node for the subject 272 is created. More specifically, the object node 268 is also identified as a subject node in one example.

The predicate 274 is not present in the node database 204 in this example. In addition, the object 276 is not present in the node database 204 as an object node. Thus, the node generation engine 212 may generate an object node for the object 276. The relation creation engine 206 then creates the relationship for the predicate 274.

In this example, the controller 202 thus performs or orchestrates actions 280 that include the creation of a new node for the subject 272 (e.g., causing the object node 268 to be identified as a subject node). The actions 280 may also include creating an object node for the object 276 and adding the predicate 274 as a relationship between the node 268 and the newly created object node for the object 276. In addition, the relationship 266 is updated to an object node because the object node 268 is no longer a literal in view of the triplet 270 and new relationship generated from the triple 270.

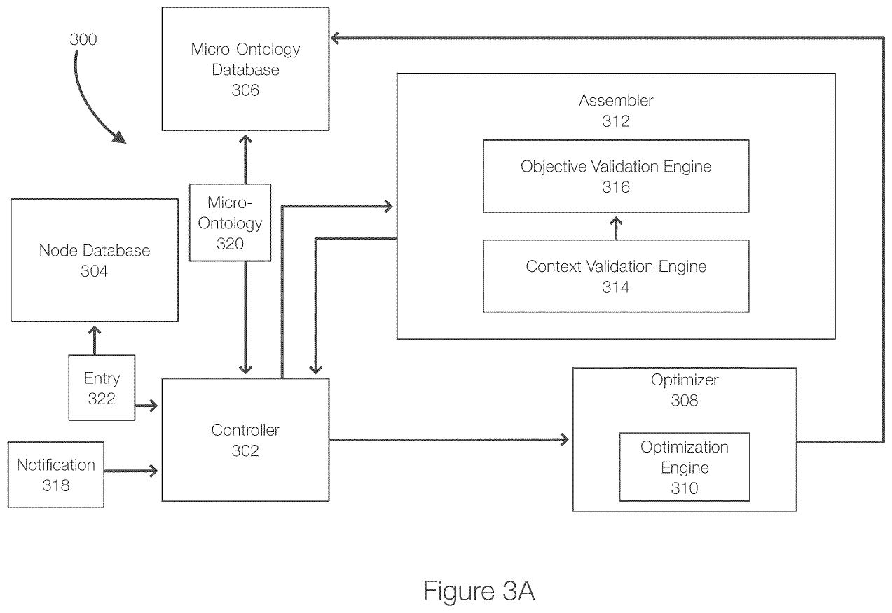

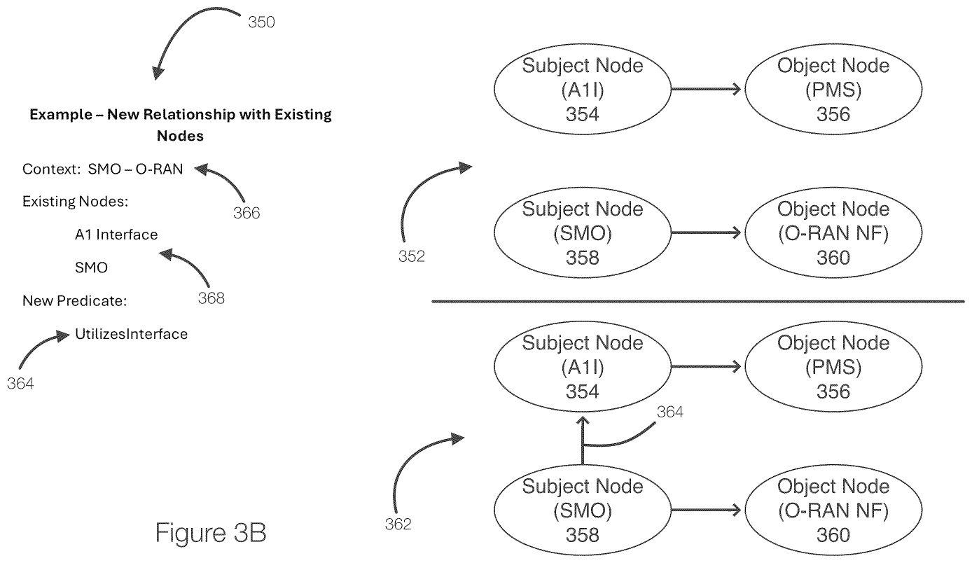

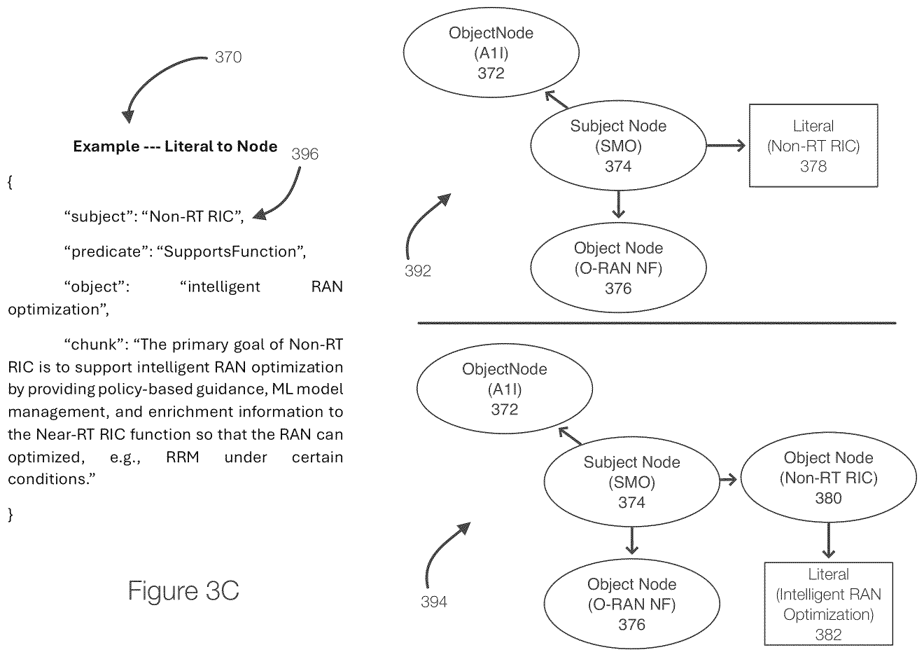

FIG. 3A discloses aspects of augmenting and/or creating a micro-ontology. FIG. 3A illustrates a micro-ontology management system 300 (system 300) that is configured to manage ontologies including micro-ontologies. More specifically in one example, the system 300 is configured to create, construct, and/or augment a micro-ontology.

In this example, a controller 302 of the system 300 may receive a notification 318 indicating that changes have been made to the node database 304. This notification 318 may related to changes (e.g., additions, removals, edits, altered data) in the node database 304. In one example, the notification 318 may include extracted text to be added to the node database 304.

Once the notification 318 is received, the controller 302 retrieve the data (e.g., an entry) from the node database 304 and retrieves a target micro-ontology 320 from the micro-ontology database 306 (database 306). For example, the controller 302 may determine that the entry may be a candidate for the target micro-ontology 320, which is retrieved.

If the notification 318, which may be an update to the node database 304, relates only to a predicate between existing subject and object nodes, the controller 302 may predict outcomes based on these established relationships using as assembler 312. Predicting the outcome may include performing an objective validation by an objective validation engine 316 and performing a context validation by a context validation engine 314.

If the notification 318 results in or relates to the generation of a new node (e.g., a subject node, an object node, a literal), the controller 302 may also coordinate with or access an assembler 212 to reassemble the micro-ontology and integrate the resulting nodes/relationships into the target micro-ontology.

When the notification 318 results in a new node for the target micro-ontology 320, the new node can be added and related to other nodes in the target micro-ontology 320. For example, when a new object node is generated in response to the notification 318 and the evaluation of the entry 322, the new object node may be associated with an existing subject node. A new predicate or relationship may also be created in this example. Thus, the existing subject node has a new relation to a new object node. In another example, a new subject node may be created.

More specifically, receiving the notification 318 may cause the controller 302 to access the entry (e.g., subject node, object node, and/or relationship) from the node database 304 and a target micro-ontology 320 from the database 306. Next, the entry 322 may be processed by the assembler 312 in light of the context and/or objective of the target micro-ontology 320.

The assembler 312 may be configured to assemble, re-assemble, or integrate the entry 322 retrieved from the node database 304 corresponding to the notification 318 into the micro-ontology 320. Generally, the assembler 312 may perform context validation and objective validation in any order.

The assembler 312 may perform an objective validation operation by inputting the entry 322 into the context validation engine 314. In one example, the engine 314 includes an LLM configured to determine whether the entry 322 complies or comports with the context of the micro-ontology 320. More specifically in one example, the micro-ontology 320 may be associated with a definition, which is often textual. For example, the target micro-ontology 320 may be defined as relating specifically to interface logic in an O-RAN (Open Radio Access Network). The LLM of the context validation engine 314 may be configured to determine whether the entry 322 complies, comports, or aligns with the definition or context of the target micro-ontology 320.

More specifically, the entry 322 may be associated with extracted text that may include a chunk, a domain, and a sub-domain. If the domain and sub-domain of the entry 322 indicate that the entry 322 has a domain of O-RAN and a sub-domain of distributed units (Dus) in an O-RAN and the context or definition of the target micro-ontology 320 relates to interfaces, then the context validation engine 314 may fail the entry 322 such that the entry 322 is not included in the target micro-ontology 320. In some examples, the entry 322 may be amended and re-evaluated by the assembler 312 or evaluated in the context of a different micro-ontology.

If the context validation engine 314 determines that the entry 322 satisfies the context or definition of the micro-ontology 320, an objective validation operation may be performed by the objective validation engine 316. In one example, the engine 316 includes an LLM configured to determine whether the entry 322 complies, comports, or aligns with an objective of the micro-ontology 320, which is distinct from the context or definition. For example, the definition of the micro-ontology 320 may relate to O-RAN interfaces while an objective of the micro-ontology 320 may be to enable energy efficiency in O-RAN interfaces. If the entry 322 is not focused on or does not have an objective of enabling energy efficiency, the objective validation engine 316 may fail the entry 322.

When the entry 322 passes both the context validation operation performed by the context validation engine 314 and the objective validation operation performed by the objective validation engine 316, the assembler 312 may reassembled the target micro-ontology 320 (e.g., the entry 322 is added to the micro-ontology 320) and return the updated micro-ontology 320 to the controller 302.

The controller may submit the updated or augmented micro-ontology 320 to the optimizer 308, which includes an optimization engine 310. The optimization engine 310 may be configured to enhance the micro-ontology 320 or the entry added to the micro-ontology 320. In one example, the optimization engine 310, which may include an LLM, may perform optimizations such as consistency optimizations, which may include aligning the relationship with existing data and standards to maintain consistency across the micro-ontology, and clarity optimizations, which may include making the relationship more clear or more unambiguous to avoid or reduce misinterpretations. The augmented or improved micro-ontology 320 is then returned to the micro-ontology database 306.

FIG. 3B discloses additional aspects of augmenting and/or creating a micro-ontology. In FIG. 3B, a notification may be received at a controller 302 that corresponds to data such as an entry 350. The entry 350 reflects that a new relationship was added to the node database in the context of existing nodes. When the entry 350 was added to the node database, because the nodes 368 existed, a new predicate 364 may have been created in the node database, which resulted in the notification to the controller 302. In addition, the SMO node may have been designated as an object node when the entry 350 was added to the node database.

In addition to retrieving data (the entry 350) from the node database, a target micro-ontology 352 is retrieved from a micro-ontology database. In this example, the micro ontology 352 includes a subject node 354 with a relationship to an object node 356. The subject node 358 has a relationship to an object node 360.

The system 300 adds, if possible, the entry 350 to the micro-ontology 352, which results in an augmented or updated ontology 362. In this example, a relationship 364, corresponding to the utilizesInterface in the entry 350, is added to the micro-ontology 364. Further, the subject node 354 also become an object node, at least with respect to the subject node 358 and the relationship 364.

In one example, the context validation engine 314 determined that the entry 350 complied, aligned, or comported with a context of the micro-ontology 352. More specifically, the context 366 aligned with the context of the micro-ontology 352. Next, the objective validation engine 316 determines whether the entry 350 (or more specifically the predicate 364 in this example), aligned, agreed, or comported with the objective of the micro-ontology 352. If the entry 350 passes the context and objective validation operations, the micro-ontology 352 is reassembled as the micro-ontology 362, returned to the controller, optimized, and returned to the micro-ontology database.

FIG. 3C discloses another example of creating and/or augmenting a micro-ontology. Prior to augmentation, the micro-ontology 392 includes a subject node 374 with a relationship to each of object nodes 372 and 376, and a relationship to a literal 378. In this example, the system 300 may augment the ontology 392, based on an entry 370 from the node database, to be the micro-ontology 394 by converting the literal 378 into an object node 380 and adding a literal 382. In this example, the new object node 380 (to the subject node 374) may also be a subject node in one example to the literal 382.

As illustrated in the entry 370, the subject 396 exists as a literal in the micro-ontology 392. Thus, the controller 302 may have a scenario where a new node is generated in the micro-ontology by the assembler 312. The object validation engine 316 and the context validation engine 314, as previously described, validate a context and objective of the entry 370 based on the context and objective of the micro-ontology 392. The LLMs may use the information in the entry 370 to perform the context validation and objective validation operations. Once the context and objective of the entry 370 are validated, the entry 370 is incorporated into the micro-ontology 392 to generate the updated micro-ontology 394, which is then optimized and returned to the micro-ontology database.

In FIG. 3C, a literal 382 is added to the micro-ontology 394, the literal 378 is converted to both an object node (of the subject node 374) and a subject node (for the literal 382). This addition to the updated micro-ontology 394 are based on the entry 370 and/or on non-failure of the context validation and objective validation operations.

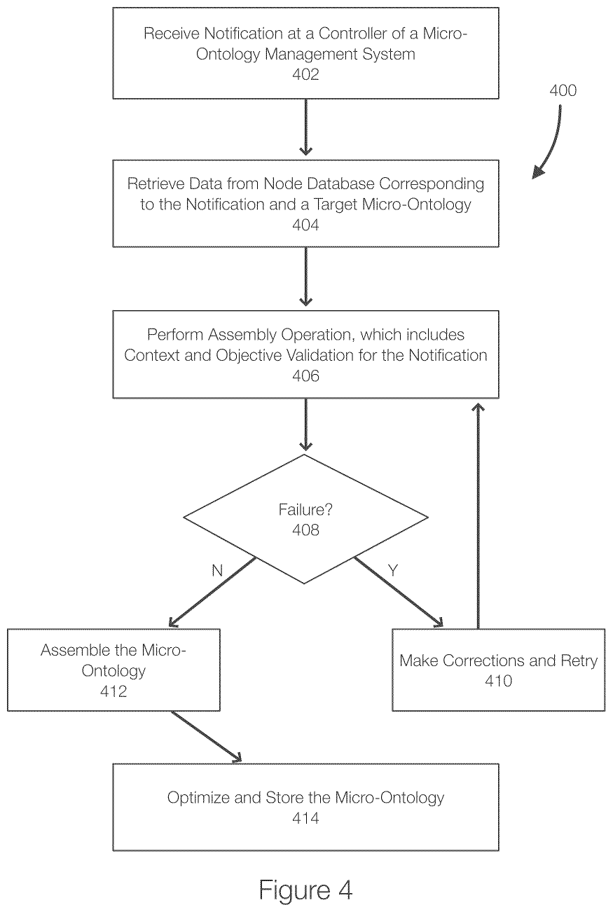

FIG. 4 discloses aspects of a method for creating and/or augmenting a micro-ontology. The method 400 includes receiving 402 a notification at a controller of a micro-ontology management system. The notification may inform that system that the node database has been updated. In response to the notification, the controller may retrieve 404 data from the node database (e.g., an entry related to the notification) and also retrieve a target micro-ontology from a micro-ontology database.

Next, the controller may perform 406 or initiate an assembly operation. The assembly operation may include a context validation operation and an objective validation operation. If either validation operation fails (Y at 408), the node data may be revised or updated and the assembly operation may be retried.

If neither of the context and objective validation operations fail (N at 408), the micro-ontology is assembled 412. This may include adding the entry to the micro-ontology previously retrieved by the controller. Next, the micro-ontology may be optimized 414 and stored in the micro-ontology database.

The validation operations may be considered to pass or fail based on a context validation threshold and an objective validation threshold. The LLMs may generate likelihoods or probabilities that may be used in determining whether the validation operations pass/fail. The threshold values may be set by a user, based on experience, adjusted, or the like.

Embodiments of the invention are configured to democratize ontology creation/augmentation. Embodiments of the invention allow for wider access and wider participation. Embodiments of the invention may include LLM-based operations for semantic precision that consider the context and objectives of micro-ontologies. Embodiments of the invention further enable micro-ontology automated validation and refinement.

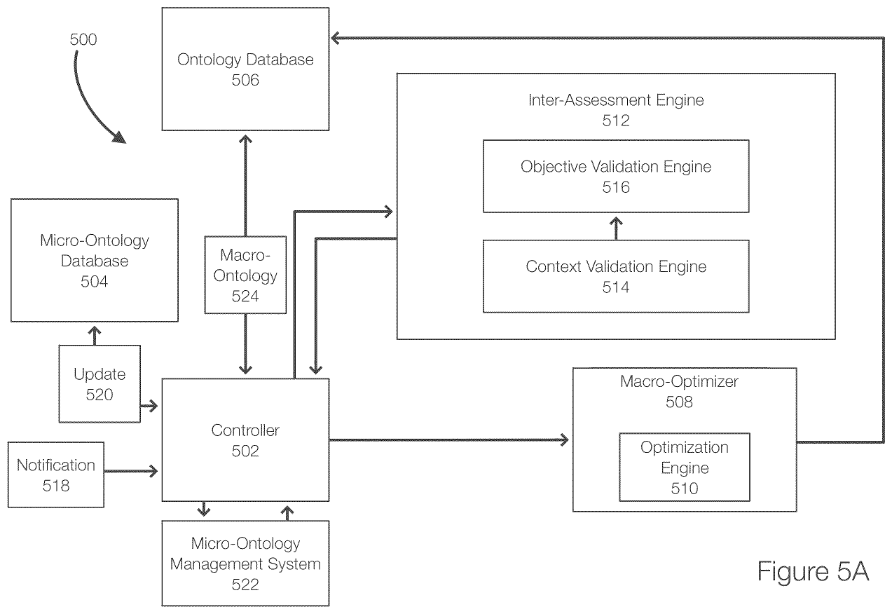

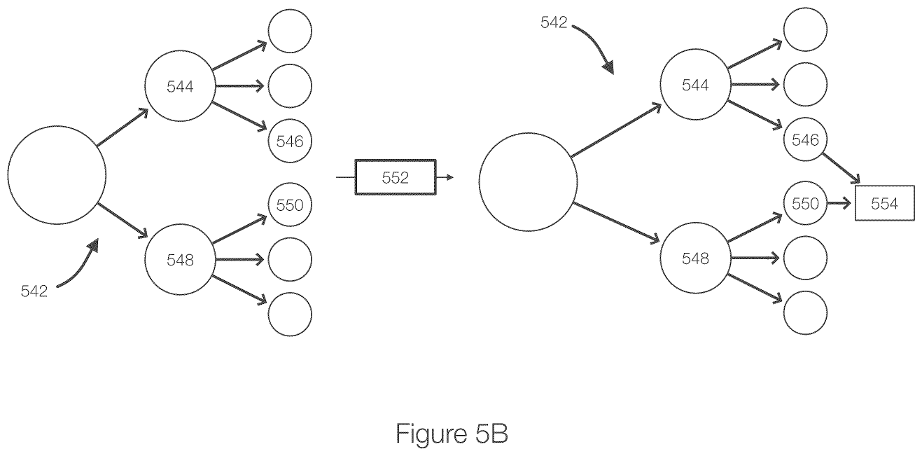

FIG. 5A discloses aspects of creating and/or augmenting a macro-ontology. FIG. 5A illustrates a macro-ontology management system 500 (system 500). The system 500 is configured to manage a macro-ontology, which may include ontologies and micro-ontologies. In one example, a notification 518 is received by a controller 502. For example, the notification 518 may occur when a micro-ontology is updated and stored in the micro-ontology database. In one example, the notification 518 relates to an update 520 made to the micro-ontology database 504.

In response to receiving the notification 518, the controller 502 may retrieved the revised data (e.g., the update 520) from the micro-ontology database 504 and an impacted macro-ontology 524 from the ontology database 506. The controller 502 may assess how the update 520 impacts the ontologies, including macro-ontologies and/or micro-ontologies, managed in the system 500. In one example, if the update 520 is confined to a micro-ontology, the, the update may be directed to a micro-ontology management system 522, which is an example of the system 300.

However, if the controller 502 determines that the update 520 relates to relationships between micro-ontologies, the update 520 may be input to the inter-assessment engine 512 (engine 512). The inter-assessment engine 512 may be configured to adjust interconnections between impacted micro-ontologies. Once the interconnections are adjusted based on the update 520, an optimization engine 510 of a macro-ontology optimizer 508 optimizes or fine-tunes the adjustments or changes. The updated macro-ontology is uploaded or stored back into the ontology database 506.

The engine 512 includes a context validation engine 514 and an objective validation engine 516. The context validation engine 514 is configured to ensure that the update 520 fits the definition and restriction of the macro-ontology 524. The objective validation engine 516 is configured to that the update 520 aligns or comports with the policy or objective of the macro-ontology 524.

If the objective validation operation performed by the engine 516 and/or the context validation operation performed by the engine 514 fail, the update 520 may be revised, corrected, or the like and retried. Otherwise, the update 520 may be rejected.

For example, the context validation engine 516 may include an LLM configured to determine whether the update 520 complies, comports, or aligns with a context (e.g., definition, restriction) of the macro-ontology 524. Similarly, the objective validation engine 516 may include an LLM configured to determine whether the update 520 complies, comports, or aligns with an objective or policy of the macro-ontology 524. The LLM of the objective validation engine 516 and the LLM of the context validation engine 514 may be trained on subject matter of the domain(s) represented by the macro-ontology.

Thus, the extracted text associated with the update 520 can be ingested and evaluated in light of the context and/or objective. In one example, the ability of an LLMs to understand the update 520 semantically ensures that the update 520 can be compared semantically to the definition and objective of the macro-ontology 524. When the similarity is sufficient in one example, (e.g., greater than an objective validation threshold and greater than a context validation threshold), the update 520 may pass the validation operations.

For example, the definition of a macro-ontology may be healthcare and the macro-ontology may include two micro-ontologies: human diseases and bird diseases. If an update is specific to one of the micro-ontologies, the system 322 may incorporate the update into the relevant micro-ontology. If the update is related to two micro-ontologies (e.g., a disease that may jump from one species to another species), the inter-assessment engine 512 may operate to validate the update. Once validated, the macro-ontology can be updated (e.g., by adding a relationship that spans different micro-ontologies).

FIG. 5B discloses aspects of creating and/or augmenting a macro-ontology. While FIG. 3C illustrates an example of an update that may be handled by the system 522, FIG. 5B illustrates an example of an update that spans different micro-ontologies of a macro-ontology. FIG. 5C illustrates a macro-ontology 542 that is associated with or that includes ontologies 544 and 548. The ontology 544 includes a micro-ontology 546 and the ontology 548 includes a micro-ontology 550.

In this example, the system 500 receives a notification and retrieves an update 552. In this example, the update was not specific to a micro-ontology, but related to two different micro-ontologies. In one example, the context validation engine 514 may determine that the update 552 aligns with the definition of the macro-ontology 540 and of the micro-ontologies 546 and 550. The objective validation engine 516 determines that the update 552 aligns with the objective of the macro-ontology and of the micro-ontologies 546 and 550. The inter-assessment engine 512 may then integrate the update 552 into the macro-ontology 540.

As illustrated in FIG. 5B, the update 552 may be incorporated as a node 554 that is included in both the micro-ontology 546 and the micro-ontology 550. For example, the node 554 may be a literal to different subject nodes in each of the micro-ontologies 546 and 550. In one example, the update 552 may result in a relationship between a node in the micro-ontology 546 and a node in the micro-ontology 550.

In one example, the context validation and objective validation operations may include validating an update with respect to a context or definition and objectives of a macro-ontology and micro-ontologies.

Once the macro-ontology 542 is updated, the optimization engine 510 may optimize the macro-ontology 524 and return the updated macro-ontology to the ontology database 506. In one example, the optimization engine 510, which may include an LLM, may perform optimizations such as consistency optimizations, which may include aligning the relationship with existing data and standards to maintain consistency across the macro-ontology, and clarity optimizations, which may include making the relationship more clear or more unambiguous to avoid or reduce misinterpretations. The augmented or improved macro-ontology 524 is then returned to the ontology database 506. To the extent that a micro-ontology is updated, the micro-ontology may be returned to the database 504.

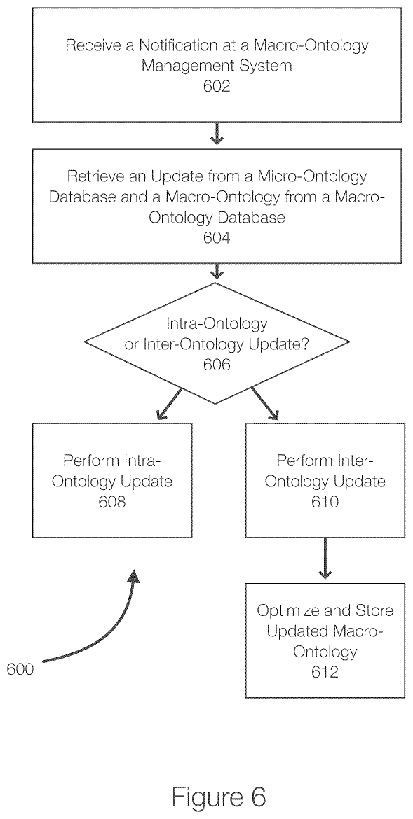

FIG. 6 discloses aspects of a method for creating and/or updating a macro-ontology. The method 600 includes receiving 602 a notification at a controller of a macro-ontology management system. The controller may retrieve 604 an update corresponding to the notification and an impacted or associated macro-ontology. The controller may assess the update to determine whether the update relates to one micro-ontology (e.g., an intra-ontology update) or multiple-micro-ontologies (e.g., an inter-micro-ontology update).

If the update is an intra-ontology update, an intra-ontology update is performed 608. This may include updating (creating and/or augmenting) a target micro-ontology as previously described. If the update relates to an inter-ontology update, an inter-ontology update is performed 610. The inter-ontology update may include performing an objective validation operation and a context validation operation on the update. Once the update is validated, the macro-ontology may be updated, which may include updating one or more micro-ontologies. The updated macro-ontology is optimized 612 and stored in the macro-ontology database.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, ontology management operations, macro and/or micro-ontology management operations, creating and/or augmenting subject nodes, predicates, relationships, and/or object nodes, context and/or objective validation operations, relationship operations, intra-ontology update operations, inter-ontology update operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.
Embodiment 1. A method comprising: receiving a notification at a controller of a macro-ontology management system, retrieving an update corresponding to the notification from a micro-ontology database, determining that the update is an inter-ontology update, wherein the update is incorporated into a micro-ontology when the update is an intra-ontology update by a micro-ontology management system, validating the update based on an objective and a context of a macro-ontology, incorporating the update into the macro-ontology when the update is validated, and storing the updated macro-ontology in a macro-ontology database.
Embodiment 2. The method of embodiment 1, wherein validating comprises inputting the update into a context validation engine that includes a first large language model configured to determine whether the update aligns with a definition of the macro-ontology.
Embodiment 3. The method of embodiment 1 and/or 2, wherein the large language model is further configured to determine whether the update aligns with definitions of multiple micro-ontologies.
Embodiment 4. The method of embodiment 1, 2, and/or 3, wherein validating comprises inputting the update into an objective validation engine that includes a second large language model configured to determine whether the update aligns with an objective of the macro-ontology.
Embodiment 5. The method of embodiment 1, 2, 3, and/or 4, wherein the large language model is further configured to determine whether the update aligns with objectives of multiple micro-ontologies.
Embodiment 6. The method of embodiment 1, 2, 3, 4, and/or 5, wherein the validating the update includes inputting extracted text into the first large language model and into the second large language model.
Embodiment 7. The method of embodiment 1, 2, 3, 4, 5, and/or 6, further comprising adding a relationship between a first micro-ontology and a second micro-ontology.
Embodiment 8. The method of embodiment 1, 2, 3, 4, 5, 6, and/or 7, further comprising optimizing the macro-ontology by performing consistency optimizations and clarity optimizations on the macro-ontology.
Embodiment 9. The method of embodiment 1, 2, 3, 4, 5, 6, 7, and/or 8, wherein the consistency operations include aligning the relationship with existing data and standards to maintain consistency across the first and second micro-ontologies and wherein the clarity optimizations include making the relationship more clear or more unambiguous to avoid or reduce misinterpretations.
Embodiment 10. The method of embodiment 1, 2, 3, 4, 5, 6, 7, 8, and/or 9, wherein the update comprises an update to a micro-ontology.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

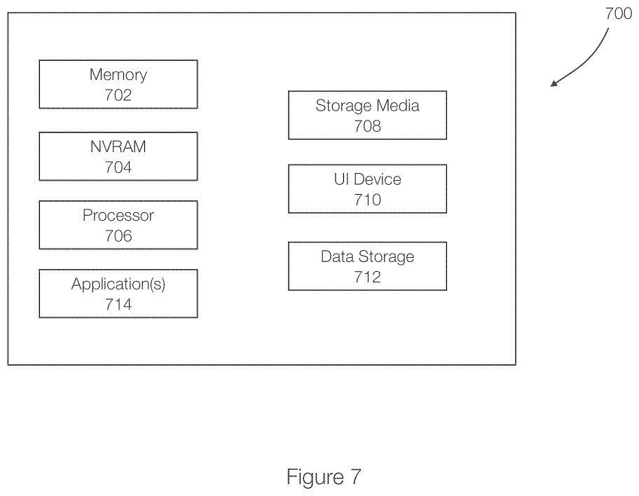

With reference briefly now to FIG. 7, any one or more of the entities disclosed, or implied, by the Figures and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

The device 700 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 700 may also represent a physical or virtual machine or server, an edge-based computing system, a cloud-based computing system, server clusters or other computing systems or environments. The device 700 may also represent multiple machines or devices, whether virtual, containerized, or physical. The device 700 may perform or execute steps or acts of the methods illustrated in the Figures.

The device 700 may represent a cloud-based system, an edge-based, system, an on-premise system, or combinations thereof. The device 700 may be a computing system that is distributed geographically. Embodiments of the invention reference a controller in different systems. However, the systems may be combined and include a single controller. The controllers may be the same controller or different controllers.

The described embodiments are to be considered in all respects only as illustrative and not restrictive. All changes which come within the meaning and range of equivalency of the claims are to be embraced within their scope.

1. A method comprising:
receiving, by a controller of a macro-ontology management system, a notification identifying a proposed update to a first micro-ontology of a macro-ontology;
retrieving, from a micro-ontology database, an update corresponding to the notification;
identifying whether the update affects only a first micro-ontology or both the first micro-ontology and a second micro-ontology of the macro-ontology, which is different from the first micro-ontology;
determining that the update is an inter-ontology update indicating that the update affects both the first micro-ontology and the second micro-ontology;
responsive to determining that the update is the inter-ontology update:
validating, by a context validation engine, the update by comparing the update against a context of the macro-ontology; and
validating, by an objective validation engine, the update by comparing the update against an objective of the macro-ontology;
receiving a context validation result from the context validation engine and an objective validation result from the objective validation engine;
incorporating the update into the macro-ontology when both context and objective validation results-update satisfy respective thresholds; and
storing the updated macro-ontology in a macro-ontology database.

2. The method of claim 1, wherein the context validation engine includes a first large language model configured to determine whether the update aligns with a definition of the macro-ontology.

3. The method of claim 2, wherein the first large language model is further configured to determine whether the update aligns with definitions of multiple micro-ontologies.

4. The method of claim 3, wherein the objective validation engine includes a second large language model configured to determine whether the update aligns with the objective of the macro-ontology.

5. The method of claim 4, wherein the second large language model is further configured to determine whether the update aligns with objectives of multiple micro-ontologies.

6. The method of claim 4, wherein extracted text is inputted into the first large language model and into the second large language model.

7. The method of claim 5, further comprising adding a relationship between the first micro-ontology and the second micro-ontology.

8. The method of claim 7, further comprising optimizing the macro-ontology by performing consistency optimizations and clarity optimizations on the macro-ontology.

9. The method of claim 8, wherein the consistency optimizations include aligning the relationship with existing data and standards to be consistent with the first and second micro-ontologies, and
wherein the clarity optimizations include rephrasing the relationship to avoid or reduce misinterpretations.

10. The method of claim 1, wherein the update is incorporated into the first micro-ontology when the update is determined to be an intra-ontology update indicating that the update affects only the first micro-ontology.

11. A non-transitory storage medium having stored therein instructions that are executable by one or more hardware processors to perform operations comprising:
receiving, by a controller of a macro-ontology management system, a notification identifying a proposed update to a first micro-ontology of a macro-ontology;
retrieving, from a micro-ontology database, an update corresponding to the notification;
identifying whether the update affects only a first micro-ontology or both the first micro-ontology and a second micro-ontology of the macro-ontology, which is different from the first micro-ontology;
determining that the update is an inter-ontology update indicating that the update affects both the first micro-ontology and the second micro-ontology;
responsive to determining that the update is the inter-ontology update:
validating, by a context validation engine, the update by comparing the update against a context of the macro-ontology; and
validating, by an objective validation engine, the update by comparing the update against an objective of the macro-ontology;
receiving a context validation result from the context validation engine and an objective validation result from the objective validation engine;
incorporating the update into the macro-ontology when both context and objective validation results satisfy respective thresholds; and
storing the updated macro-ontology in a macro-ontology database.

12. The non-transitory storage medium of claim 11, wherein the context validation engine includes a first large language model configured to determine whether the update aligns with a definition of the macro-ontology.

13. The non-transitory storage medium of claim 12, wherein the first large language model is further configured to determine whether the update aligns with definitions of multiple micro-ontologies.

14. The non-transitory storage medium of claim 13, wherein the objective validation engine includes a second large language model configured to determine whether the update aligns with the objective of the macro-ontology.

15. The non-transitory storage medium of claim 14, wherein the second large language model is further configured to determine whether the update aligns with objectives of multiple micro-ontologies.

16. The non-transitory storage medium of claim 14, wherein extracted text is inputted into the first large language model and into the second large language model.

17. The non-transitory storage medium of claim 15, further comprising adding a relationship between the first micro-ontology and a-the second micro-ontology.

18. The non-transitory storage medium of claim 17, further comprising optimizing the macro-ontology by performing consistency optimizations and clarity optimizations on the macro-ontology.

19. The non-transitory storage medium of claim 18, wherein the consistency optimizations include aligning the relationship with existing data and standards to be consistent with the first and second micro-ontologies, and
wherein the clarity optimizations include rephrasing the relationship to avoid or reduce misinterpretations.

20. The non-transitory storage medium of claim 11, wherein the update is incorporated into the first micro-ontology when the update is determined to be an intra-ontology update indicating that the update affects only the first micro-ontology.
